(19) United States
(12) Patent Application Publication
(10) Pub. No.: US 2007/0050466 A1
(43) Pub. Date: Mar. 1, 2007

(54) Automated sharing of multimedia files

(75) Inventors: Christian Kraft, Frederiksberg (DK); Peter Nielsen, Lyngby (DK)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/219,312

(22) Filed: Sep. 1, 2005

(51) Int. Cl. G06F 15/167

(52) U.S. Cl. 709/212

(57) ABSTRACT

The invention relates to a method for sharing multimedia files from a terminal. The method comprises: setting a starting point for a capturing session of multimedia files; capturing at least one multimedia file with an appropriate capturing application; setting an end point for the capturing session; and creating automatically at least one message including the at least one captured multimedia file for further transmission to another terminal.

### FIELD OF THE INVENTION

The invention relates to controlling a terminal adapted to process multimedia files and especially to transmitting multimedia files to a wireless terminal.

### BACKGROUND OF THE INVENTION

The properties of the latest mobile station models include not only conventional telephone functions but also various multimedia functions that enable the creation and processing of multimedia files and their transmission on to other mobile stations or to a computer, for instance, for further processing. Mobile stations of this type typically comprise a digital camera, and the images produced by it can be transmitted to other telecommunications devices by using e-mail or a multimedia messaging service (MMS), for instance. The fact that such multimedia mobile stations have become common has made the sharing and distribution of images and other multimedia files between different terminals very popular.

A typical situation in sharing images and other multimedia files is that a set of images or other multimedia files are captured by an appropriate application, e.g. a camera application, of a terminal and then stored in a memory of the terminal. When the user of the terminal wants to share a copy of one or more of them, he has to send one multimedia file (e.g. a still image) at a time from the camera application, or if the camera application has been closed, he has to open an image gallery and pick one image at a time from there and then send the selected images separately. Furthermore, a new slide needs to be created for every single image being added. Accordingly, sending multiple images is a very slow process, and in terms of usability, it is inconvenient and cumbersome.

### SUMMARY OF THE INVENTION

Now there is invented an improved method and technical equipment implementing the method, by which sharing of recently captured multimedia files is significantly simplified. Various aspects of the invention include a method, an electronic device and a computer program, which are characterized by what is stated in the independent claims. Various embodiments of the invention are disclosed in the dependent claims.

According to a first aspect, a method according to the invention is based on the idea of sharing multimedia files from a terminal, whereby the method comprises setting a starting point for a capturing session of multimedia files; capturing at least one multimedia file with an appropriate capturing application; setting an end point for the capturing session; and creating automatically at least one message including the at least one captured multimedia file for further transmission to another terminal.

According to an embodiment, the multimedia file is one of the following: a digital image file, a digital video file, a digital audio file; and the capturing is carried out by a camera and/or an audio application arranged in connection with the terminal.

According to an embodiment, the starting point and the end point of the capturing session is set by the user of the terminal by pressing a dedicated capturing session button in the terminal.

According to an embodiment, the starting point of the capturing session is set to coincide with the start of the capturing application in the terminal.

According to an embodiment, the end point of the capturing session is set to coincide with the termination of the capturing application in the terminal.

According to an embodiment, the method further comprises transmitting the at least one message as a MMS message to said another terminal.

According to an embodiment, the method further comprises transmitting the at least one message as an email message or as file transfer to said another terminal.

The arrangement according to the invention provides significant advantages. It enables the user of the terminal to easily and quickly to provide multiple image files and other multimedia files for sharing with other users of terminals. Since the user of the terminal does not have to send one image file at a time or to navigate through the menu system of the terminal to find recently captured images any longer, sending a group of images and other multimedia files is facilitated significantly. Accordingly, the usability of the terminal and its multimedia applications is enhanced considerably.

According to a second aspect, there is provided a mobile terminal for sharing multimedia files, the terminal comprising: means for setting a starting point for a capturing session of multimedia files; means for capturing at least one multimedia file; means for setting an end point for the capturing session; and means for creating automatically at least one message including the at least one captured multimedia file for further transmission to another terminal.

According to a third aspect, there is provided a computer program product, stored on a computer readable medium and executable in a data processing device, for sharing multimedia files, the computer program product comprising a computer program code section for setting a starting point for a capturing session of multimedia files; a computer program code section for capturing at least one multimedia file; a computer program code section for setting an end point for the capturing session; and a computer program code section for creating automatically at least one message including the at least one captured multimedia file for further transmission to another terminal.

### LIST OF DRAWINGS

In the following, various embodiments of the invention will be described in more detail with reference to the appended drawings, in which

FIG. 1 shows an electronic device according to an embodiment of the invention in a reduced block chart; and

FIG. 2 shows a flow chart of a method for sharing multimedia files according to an embodiment of the invention.

### DESCRIPTION OF EMBODIMENTS

In the following, the invention will be illustrated by way of example by using embodiments that are especially related to sharing digital image files to other terminals. The invention is, however, not limited to (still) image files only, but the same procedure is also applicable to other multimedia files, such as digital video or audio files.

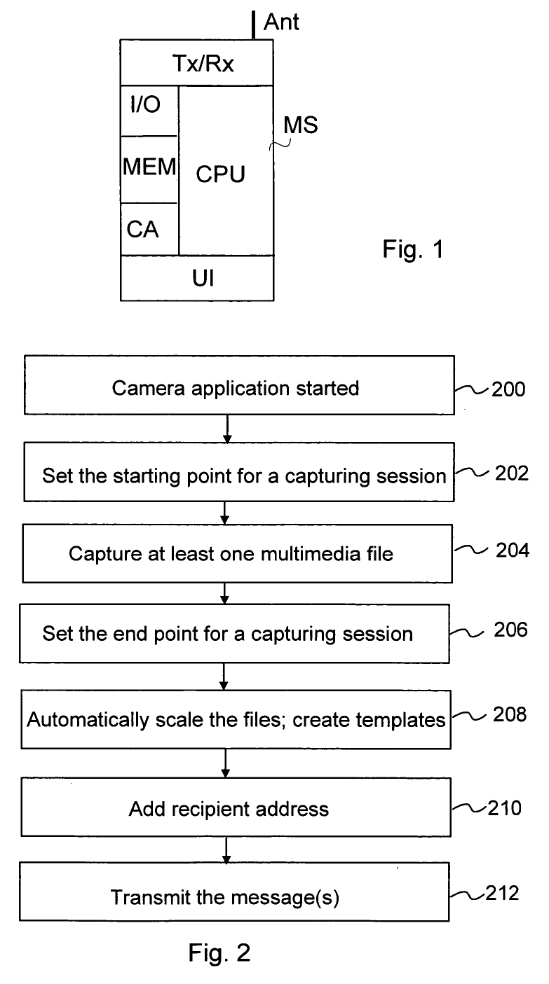

FIG. 1 shows a wireless terminal MS, such as a mobile station, which comprises camera functionality CA. A mobile station generally refers to a device comprising means for implementing wireless data transfer. Such devices include devices capable of data transfer with a public land mobile network, such as a GSM/GPRS network or a third-generation (e.g. 3GPP) network. Moreover, many of the recent mobile station models are capable of WLAN access e.g. via a wireless local area network system IEEE 802.11b. Furthermore, most mobile stations support the Bluetooth system, which provides a short-range radio access. It should be noted that the invention is also applicable to mobile stations without camera functionality but with the capability of downloading multimedia files over an available telecommunications connection. It should further be noted that the invention is also applicable to mobile stations equipped with a camera, in which the camera is not integrated to the mobile station, but the camera producing image information is attached to the mobile station over wire or wirelessly. It should yet further be noted that the invention is not limited to mobile stations, but it is also possible to apply the invention to portable or fixed personal computers, portable digital assistant (PDA) devices, and other electronic devices suited for processing and transmission of files.

The mobile station MS comprises a central processing unit (CPU), memory (MEM), and I/O system (I/O). All necessary information is stored in the memory (MEM) of the device. The memory (MEM) comprises a read-only memory section formed for instance of a ROM memory, and a read-write memory section formed for instance of a RAM (Random Access Memory) and/or FLASH memory. Through the I/O system (I/O), the device communicates for instance with other devices, the network and the user. In particular, the I/O system comprises a transceiver Tx/Rx arranged to transmit and receive data transfer according to various wireless data transfer protocols through an antenna Ant. A user interface (UI), which is part of the I/O system (I/O), comprises the necessary interface, such as a display, keys, loudspeaker, and/or microphone, for communicating with the user. Information received from the different components of the device is transmitted to the central processing unit (CPU) that comprises one or more processors and processes the received information as desired.

The mobile station MS of FIG. 1 also comprises a camera CA able to function using any known digital imaging technique. The camera CA transforms light into electric charges in an image sensor, defines RGB values for dots and transforms them into a digital format. It should be noted that, in addition to still images, the camera CA is also able to store video images. The central processing unit CPU processes, for instance compresses, the digital-format image information and stores it into the memory MEM. The mobile station of FIG. 1 can, in addition to or instead of the camera, comprise means for generating and/or downloading digital sound material. This sound material can be music files compressed with an MP3 compression format, for instance.

The flow chart of FIG. 2 illustrates an arrangement according to an embodiment of the invention for transmitting multimedia files between two wireless terminals, such as mobile stations. The embodiment of FIG. 2 uses digital still images recorded by a camera CA as examples of the multimedia files. In this embodiment, either the user of the terminal first starts (200) the camera application of the terminal, or the camera application can be started (200) at the same time when the terminal itself is switched on, i.e. the camera application is at user's disposal whenever the power of the terminal is switched on. At an appropriate moment decided by the user of the terminal, a starting point for a capturing session is set (202), after which moment all images captured by the camera are included in said capturing session.

The starting point can preferably be set and the capturing session can be activated by using a special capturing session button included in the terminal device, or e.g. by pressing two or more buttons in combination, either simultaneously or in sequence. The button may preferably be a programmable button (i.e. “a softkey”) in connection with the display, which may be provided with various functions, depending on the operating state of the terminal device so that the function being used at a given time is shown as text on the display. Alternatively, the button may be implemented as a separate button in the terminal device. The message function may also be implemented as a menu-directed function, but particularly in connection with small communication devices, it is preferable that the activation of the message function may be implemented using as few procedures as possible.

When the user has captured (204) the images that the user wants to include in the session, an end point for a capturing session is set (206). Again, the same capturing session button can preferably be used for terminating the capturing session. Thereafter, the images included in the capturing session are scaled appropriately and suitable image templates are created for the transmission of the images (208). Address information of a recipient is added (210) to the one or more image message templates, and finally, the images are sent (212) as messages of appropriate format to the recipient.

According to an embodiment, an MMS message is used as the presentation format of the message with the image templates attached thereto as MMS image slides.

According to an embodiment, an e-mail message can be used as a similar message, to which the image templates are attached as an attachment. The image templates can also be attached to a structural document format, such as an HTML, XHTML or XML document. After the message is generated, it is transmitted (212) to the recipient by using an available, preferably wireless, data transfer method. Message transfer can preferably take place for instance using a GPRS protocol with a WAP or TCP/IP protocol on top of it as the transfer protocol, and FTP (File Transfer Protocol) or HTTP (HyperText Transfer Protocol) data transfer. Likewise, a WLAN or a Bluetooth connection can be used as the data transfer method. It is also possible that the transmission of the image files is delayed to a later time, if a higher-quality telecommunications connection or one that is less expensive is desired for the transmission of the image files.

According to an embodiment, the starting point for the capturing session is set (202) to coincide with the start of the camera application (200). Accordingly, the capturing session starts automatically with camera application, and the user has to only select the end point for the capturing session (206). All the images captured till then are included in the capturing session, and transmitted to the recipient, if desired by the user.

According to an embodiment, the end point for the capturing session is automatically set (206) to coincide with the termination of the camera application. In other words, when the user terminates the camera application, the user is requested by the application whether the user wants to include all the images captured till then to a capturing session. The starting point for the capturing session may be either set by the user or it may be the start of the camera application. If the user accepts the request, the images of the capturing session are then transmitted to recipient.

This procedure provides the advantage that it enables the user of the terminal to easily and quickly to provide multiple image files and other multimedia files for sharing with other users of terminals. Since the user of the terminal does not have to send one image file at a time or to navigate through the menu system of the terminal to find recently captured images any longer, sending a group of images and other multimedia files is facilitated significantly. Accordingly, the usability of the terminal and its multimedia applications is enhanced considerably.

Above, the invention is illustrated by way of example through the sharing of still image files, but the procedure of the invention can correspondingly be applied to any multimedia files. For instance, it is possible to attach to the above message a short clip of large video or audio files. In case of video and audio files, the above step of scaling can be replaced by a step of compressing the files with a compression scheme that is more efficient than the one used normally.

In a wireless terminal, the functions of the invention can preferably be implemented by software SW downloaded to the terminal, which, when executed in the central processing unit CPU, makes the mobile station MS to perform actions according to the invention. The functions of the software SW can be distributed to several separate software components that communicate with each other. The computer software may be stored into any memory means, such as the hard disk of a PC or a CD-ROM disc, from where it can be loaded into the memory of mobile terminal. The computer software can also be loaded through a network, for instance using a TCP/IP protocol stack. It is also possible to use hardware solutions or a combination of hardware and software solutions for implementing the inventive means.

It is obvious that the present invention is not limited solely to the above-presented embodiments, but it can be modified within the scope of the appended claims.

What is claimed is:

1. A method for sharing multimedia files from a terminal, the method comprising:
setting a starting point for a capturing session of multimedia files;
capturing at least one multimedia file with an appropriate capturing application;
setting an end point for the capturing session; and
creating automatically at least one message including the at least one captured multimedia file for further transmission to another terminal.

2. The method according to claim 1, wherein
the multimedia file is one of the following:
a digital image file
a digital video file
a digital audio file; and
the capturing is carried out by a camera and/or an audio application arranged in connection with the terminal.

3. The method according to claim 1, wherein
the starting point and the end point of the capturing session is set by the user of the terminal by pressing a dedicated capturing session button in the terminal.

4. The method according to claim 1, wherein
the starting point of the capturing session is set to coincide with the start of the capturing application in the terminal.

5. The method according to claim 1, wherein
the end point of the capturing session is set to coincide with the termination of the capturing application in the terminal.

6. The method according to claim 1, further comprising:
transmitting the at least one message as a MMS message to said another terminal.

7. The method according to claim 1, further comprising:
transmitting the at least one message as an email message or as file transfer to said another terminal.

8. A terminal for sharing multimedia files, the terminal comprising:
means for setting a starting point for a capturing session of multimedia files;
means for capturing at least one multimedia file;
means for setting an end point for the capturing session; and
means for creating automatically at least one message including the at least one captured multimedia file for further transmission to another terminal.

9. The terminal according to claim 8, wherein
the multimedia file is one of the following:
a digital image file
digital video file
digital audio file; and
the terminal comprises a camera and/or an audio application for carrying out the capturing.

10. The terminal according to claim 8, the terminal comprising:
a dedicated capturing session button for enabling the user of the terminal to set the starting point and the end point of the capturing session.

11. The terminal according to claim 8, wherein
the starting point of the capturing session is set to coincide with the start of the capturing application in the terminal.

12. The terminal according to claim 8, wherein
the end point of the capturing session is set to coincide with the termination of the capturing application in the terminal.

13. The terminal according to claim 8, further comprising:
means for transmitting the at least one message as a MMS message to said another terminal.

14. The terminal according to claim 8, further comprising:
means for transmitting the at least one message as an email message or as file transfer to said another terminal.

15. A computer program product, stored on a computer readable medium and executable in a data processing device, for sharing multimedia files, the computer program product comprising:
a computer program code section for setting a starting point for a capturing session of multimedia files;
a computer program code section for capturing at least one multimedia file;
a computer program code section for setting an end point for the capturing session; and
a computer program code section for creating automatically at least one message including the at least one captured multimedia file for further transmission to another terminal.

16. The computer program product according to claim 15, wherein
the multimedia file is one of the following:
a digital image file
a digital video file
a digital audio file; and
the computer program code section for capturing at least one multimedia file is in operational connection with a camera and/or an audio application in the terminal.

17. The computer program product according to claim 15, wherein
the computer program code sections for setting the starting point and the end point of the capturing session are responsive to user intervention via a dedicated capturing session button in the terminal.
